(19) United States
(12) Patent Application Publication
(10) Pub. No.: US 2026/0018873 A1
(43) Pub. Date: Jan. 15, 2026

(54) ASSEMBLY STRUCTURE OF PROTECTIVE COVER AND ELECTRICAL CONNECTION BOX

(71) Applicants: Yazaki Corporation, Tokyo (JP); TOYOTA JIDOSHA KABUSHIKI KAISHA, Toyota-shi (JP)

(72) Inventors: Kazuki KOBAYASHI, Shizuoka (JP); Naoki SAKAGUCHI, Shizuoka (JP); Shinya OISHI, Shizuoka (JP); Yoshikazu EZUKA, Shizuoka (JP); Shogo TOMIHIRA, Nisshin-shi (JP)

(73) Assignees: Yazaki Corporation, Tokyo (JP); TOYOTA JIDOSHA KABUSHIKI KAISHA, Toyota-shi (JP)

(21) Appl. No.: 19/257,939

(22) Filed: Jul. 2, 2025

(30) Foreign Application Priority Data
Jul. 12, 2024 (JP) 2024-112194

(51) Int. Cl. H02G 3/08

(52) U.S. Cl. CPC H02G 3/081

(57) ABSTRACT

A first locking body includes a locking portion configured to lock a first locked body of a protective cover at a temporary holding position and hold it at the position, the first locked body includes a cantilevered flexible portion that is deflection deformable in an axial direction of a rotation shaft, and a locked protrusion that is locked to the locking portion at the temporary holding position, and is held at the position, and a locked protrusion) is provided with an input portion that, when a force is acted on an abutment position with the locking portion when the protective cover at the temporary holding position is turned in a closing direction, receives a reaction force of the force from the abutment position and deflection deforms the flexible portion to go over the locking portion.

### CROSS-REFERENCE TO RELATED APPLICATION(S)

The present application claims priority to and incorporates by reference the entire contents of Japanese Patent Application No. 2024-112194 filed in Japan on Jul. 12, 2024.

### BACKGROUND OF THE INVENTION

### 1. Field of the Invention

The present invention relates to an assembly structure of a protective cover and an electrical connection box.

### 2. Description of the Related Art

Conventionally, in an electrical connection box, it is known that an electrical connecting portion exposed from an opening is covered with a protective cover together with the opening, and the protective cover is opened around an axis of a rotation shaft to perform connection work or the like of a conductive component with respect to the electrical connecting portion. This type of electrical connection box is disclosed in, for example, JP 2014-027 724 A.

In the electrical connection box, the manufacturing process and the connecting process of the conductive component to the electrical connecting portion may each be performed at different places. In this case, it is necessary to convey an electrical connection box manufactured at a certain place to another place. Then, it is desirable that the electrical connection box is conveyed to another place in a state in which the protective cover is opened in view of workability of the connection work at another place to where it is conveyed. However, in the conventional electrical connection box, the protective cover cannot be kept at the open position, and it needs to be conveyed to another place in a state in which the protective cover is closed at the closed position. Therefore, in the conventional electrical connection box, the work of opening the protective cover from the closed position to the open position before starting the connection work of the conductive component is required.

### SUMMARY OF THE INVENTION

Therefore, an object of the present invention is to provide an assembly structure of a protective cover and an electrical connection box that can improve assembly workability.

In order to achieve the above mentioned object, an assembly structure of a protective cover according to one aspect of the present invention includes a protective cover configured to expose an opening of a main body of an assembly object at an open position with respect to the assembly object and cover the opening with a cover main body at a closed position with respect to the assembly object; a rotation shaft provided on one of the protective cover and the assembly object; a bearing provided on the other of the protective cover and the assembly object, the bearing enabling the protective cover to turn around an axis of the rotation shaft between the open position and the closed position; and a temporary holding mechanism configured to temporarily hold the protective cover at a temporary holding position by locking a first locked body of the protective cover to a first locking body of the assembly object at the temporary holding position further turned in an opening direction than the open position, wherein the first locking body includes a locking portion that locks the first locked body at the temporary holding position and holds the first locked body at the position on at least one of both ends as viewed in an axial direction of the rotation shaft, the first locked body includes a cantilevered flexible portion that projects out from the cover main body in the opening direction and is deflection deformable in the axial direction, and a locked protrusion that projects out from a free end of the flexible portion in the axial direction, is locked to the locking portion at the temporary holding position, and is held at the position, and the locked protrusion is provided with an input portion that, by applying a force to an abutment position with the locking portion when the protective cover at the temporary holding position is turned in a closing direction, receives a reaction force of the force from the abutment position and deflection deforms the flexible portion to go over the locking portion.

In order to achieve the above mentioned object, an assembly structure of a protective cover according to another aspect of the present invention includes a protective cover configured to expose an opening of a main body of an assembly object at an open position with respect to the assembly object and cover the opening with a cover main body at a closed position with respect to the assembly object; a rotation shaft provided on one of the protective cover and the assembly object; a bearing provided on the other of the protective cover and the assembly object, the bearing enabling the protective cover to turn around an axis of the rotation shaft between the open position and the closed position; and a temporary holding mechanism configured to temporarily hold the protective cover at a temporary holding position by locking a first locked body of the assembly object to a first locking body of the protective cover at the temporary holding position further turned in an opening direction than the open position, wherein the first locking body includes a locking portion that locks the first locked body at the temporary holding position and holds the first locked body at the position on at least one of both ends as viewed in an axial direction of the rotation shaft, the first locked body includes a cantilevered flexible portion that projects out from the main body of the assembly object in the closing direction and is deflection deformable in the axial direction, and a locked protrusion that projects out from a free end of the flexible portion in the axial direction, is locked to the locking portion at the temporary holding position, and is held at the position, and the locked protrusion is provided with an input portion that, by applying a force to an abutment position with the locking portion when the protective cover at the temporary holding position is turned in the closing direction, receives a reaction force of the force from the abutment position and deflection deforms the flexible portion to go over the locking portion.

In order to achieve the above mentioned object, an electrical connection box according to still another aspect of the present invention includes an accommodation member configured to accommodate, in an accommodation chamber, an electrical connecting member provided with an electrical connecting portion for physically and electrically connecting a counterpart conductive component; a cover member assembled to the accommodation member to cover the accommodation chamber with a main body, and configured to expose the electrical connecting portion from an opening of the main body; a protective cover configured to expose the electrical connecting portion together with the opening at an open position with respect to the cover member, and covers the opening and the electrical connecting portion with a cover main body at a closed position with respect to the cover member; a rotation shaft provided on one of the protective cover and the cover member; a bearing provided on the other of the protective cover and the cover member and configured to be able to turn the protective cover around an axis of the rotation shaft between the open position and the closed position; and a temporary holding mechanism configured to temporarily hold the protective cover at a temporary holding position by locking a first locked body of the protective cover to a first locking body of the cover member at the temporary holding position further turned in an opening direction than the open position, wherein the first locking body includes a locking portion that locks the first locked body at the temporary holding position and holds the first locked body at the position on at least one of both ends as viewed in the axial direction of the rotation shaft, the first locked body includes a cantilevered flexible portion that projects out from the cover main body in the opening direction and is deflection deformable in the axial direction, and a locked protrusion that projects out from a free end of the flexible portion in the axial direction, is locked to the locking portion at the temporary holding position, and is held at the position, and the locked protrusion is provided with an input portion that, by applying a force to an abutment position with the locking portion when the protective cover at the temporary holding position is turned in a closing direction, receives a reaction force of the force from the abutment position and deflection deforms the flexible portion to go over the locking portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating an assembly structure of a protective cover and an electrical connection box according to an embodiment;

FIG. 2 is a perspective view illustrating a main point of the assembly structure of the protective cover and the electrical connection box according to the embodiment, and illustrates the protective cover at a temporary holding position;

FIG. 3 is an exploded perspective view of the assembly structure of the protective cover and the electrical connection box according to the embodiment as viewed from another angle;

FIG. 4 is a perspective view of a main point of the assembly structure of the protective cover and the electrical connection box according to the embodiment as viewed from another angle, and illustrates the protective cover at the temporary holding position;

FIG. 5 is a cross-sectional view taken along line X-X of FIG. 4;

FIG. 6 is a cross-sectional view taken along line Y-Y of FIG. 4;

FIG. 7 is a perspective view illustrating a main point of the assembly structure of the protective cover and the electrical connection box according to the embodiment, and illustrates the protective cover at an open position;

FIG. 8 is a perspective view of a main point of the assembly structure of the protective cover and the electrical connection box according to the embodiment as viewed from another angle, and illustrates the protective cover at the open position;

FIG. 9 is a cross-sectional view taken along line X-X of FIG. 8; and

FIG. 10 is a perspective view illustrating a main point of the assembly structure of the protective cover and the electrical connection box according to the embodiment, and illustrates the protective cover at a closed position.

### DETAILED DESCRIPTION OF THE PREFERRED EMBODIMENTS

Hereinafter, an embodiment of an assembly structure of a protective cover and an electrical connection box according to the present invention will be described in detail with reference to the drawings. Note that the present invention is not limited by the embodiment.

### EMBODIMENT

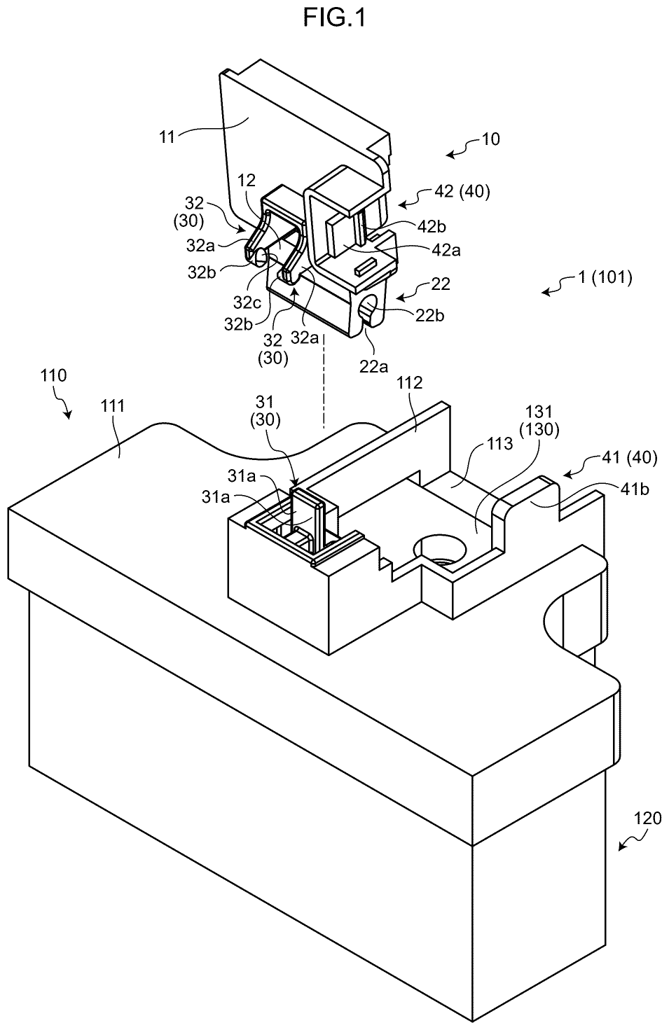

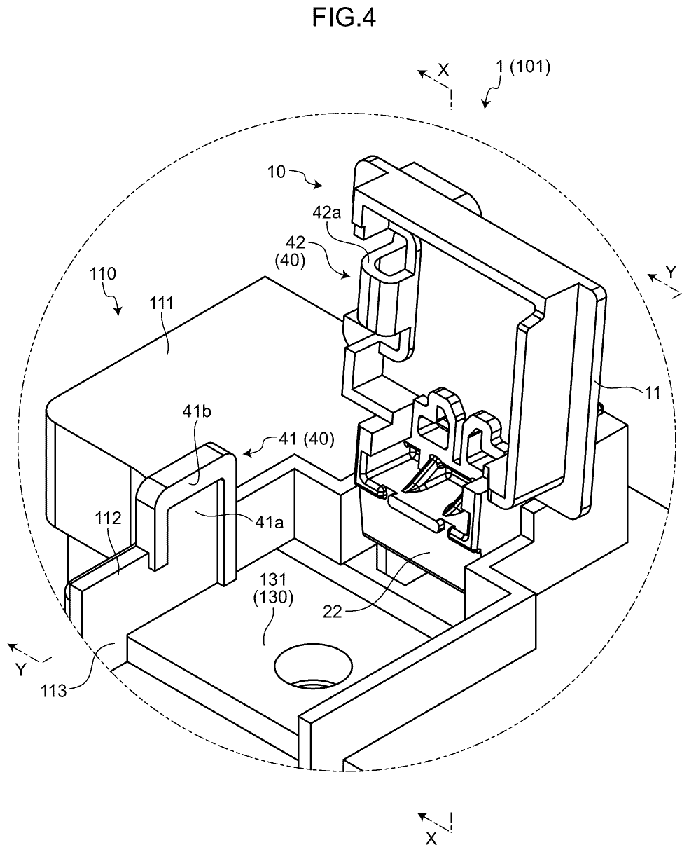

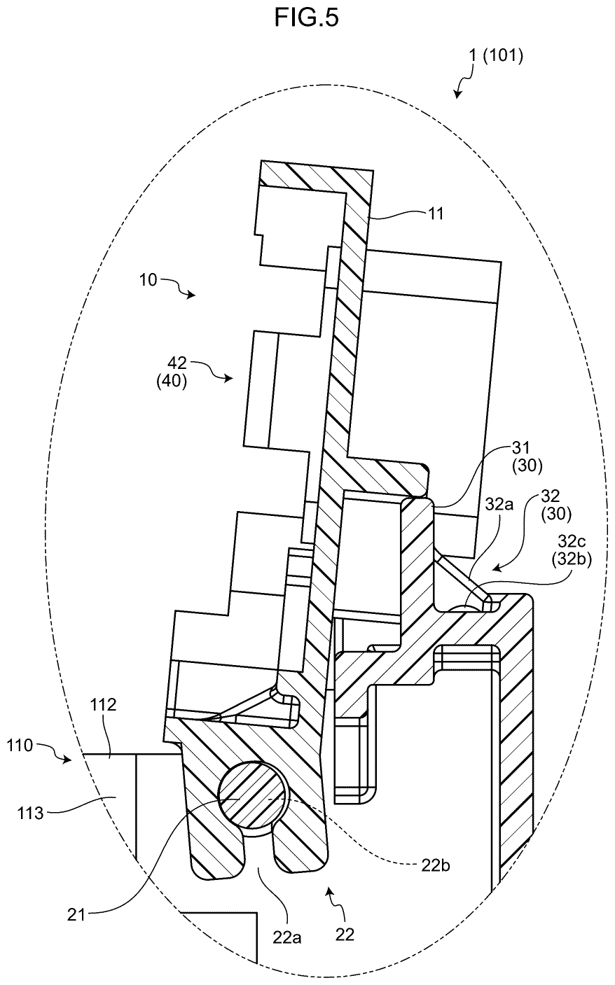

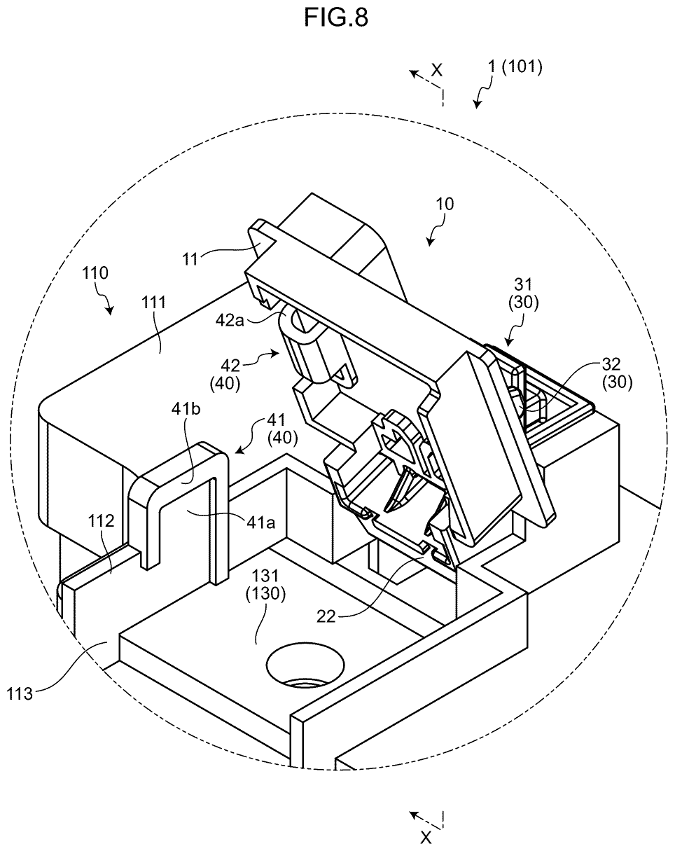

One of embodiments of an assembly structure of a protective cover and an electrical connection box according to the present invention will be described with reference to FIGS. 1 to 10.

Reference numeral 1 in FIGS. 1 to 10 indicates an assembly structure of a protective cover of the present embodiment. Reference numeral 101 in FIGS. 1 to 10 indicates an electrical connection box provided with an assembly structure 1 of the protective cover.

The assembly structure 1 includes a protective cover 10 configured to expose an opening 112 of a main body 111 of an assembly object 110 at an open position with respect to the assembly object 110 and cover the opening 112 with a cover main body 11 at a closed position with respect to the assembly object 110 (FIGS. 1 to 10). The assembly structure 1 includes a rotation shaft 21 provided on one of the protective cover 10 and the assembly object 110, and a bearing 22 provided on the other of the protective cover 10 and the assembly object 110 and configured to be able to turn the protective cover 10 around the axis of the rotation shaft 21 between the open position and the closed position (FIGS. 1, 3 to 5, and 8 to 10). Furthermore, the assembly structure 1 includes a temporary holding mechanism 30 configured to temporarily hold the protective cover 10 at a temporary holding position turned further in the opening direction than the open position (FIGS. 1 to 3 and 5 to 10). The temporary holding mechanism 30 temporarily holds the protective cover 10 at the temporary holding position by locking a locked body (hereinafter, referred to as a “first locked body”) 32 of the protective cover 10 to a locking body (hereinafter referred to as a “first locking body”) 31 of the assembly object 110 at the temporary holding position (FIGS. 1 to 3 and FIGS. 5 to 10).

In the present embodiment, an electrical connection box 101 is illustrated as an example of an application target of the assembly structure 1.

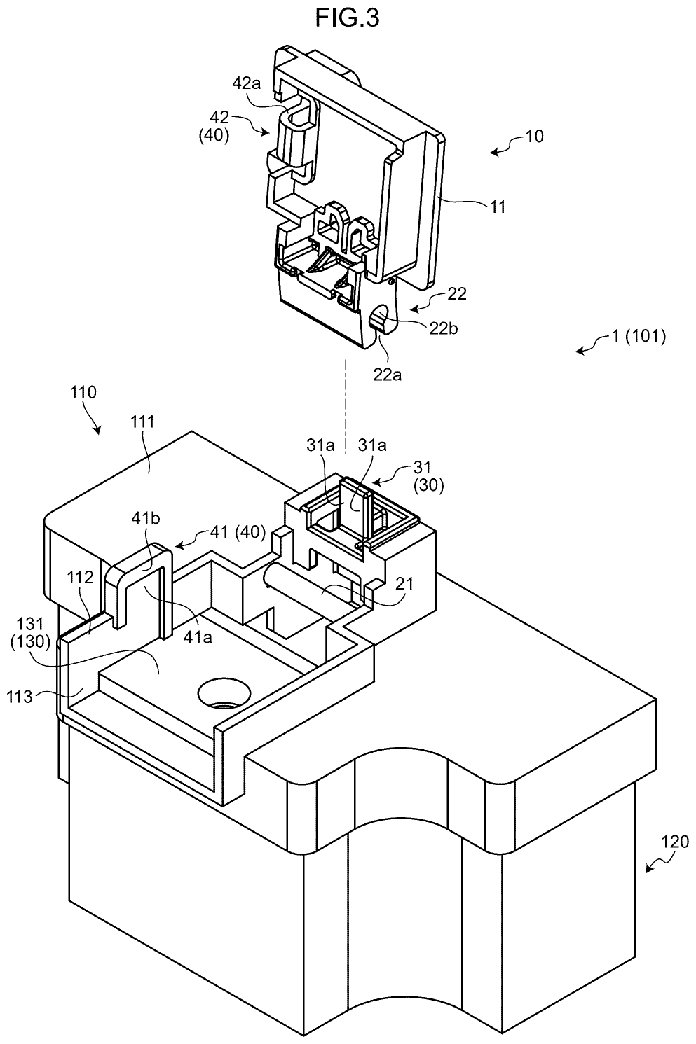

The electrical connection box 101 includes an accommodation member 120 molded with an insulating material such as a synthetic resin (FIGS. 1 and 3). The accommodation member 120 accommodates an electrical connecting member 130 in an accommodation chamber. The electrical connecting member 130 is, for example, a metal bus bar, and is provided with an electrical connecting portion 131 for physically and electrically connecting a counterpart conductive component (FIGS. 1 to 4). Here, the electrical connecting portion 131 is formed in a rectangular flat plate shape.

In addition, the electrical connection box 101 includes a cover member serving as the assembly object 110 of the protective cover 10 (FIGS. 1 to 10). Hereinafter, the assembly object 110 may be rewritten as the cover member 110. The cover member 110 is assembled to the accommodation member 120 to cover the accommodation chamber of the accommodation member 120 with the main body 111, and exposes the electrical connecting portion 131 from the opening 112 of the main body 111. A square accommodation chamber 113 configured to accommodate the electrical connecting portion 131 is formed in the main body 111 of the cover member 110 illustrated here (FIGS. 1 to 4). One plane of the electrical connecting portion 131 is placed on the bottom surface of the accommodation chamber 113. Then, the accommodation chamber 113 exposes the electrical connecting portion 131 from the rectangular opening 112 arranged to face the other plane of the electrical connecting portion 131 at an interval.

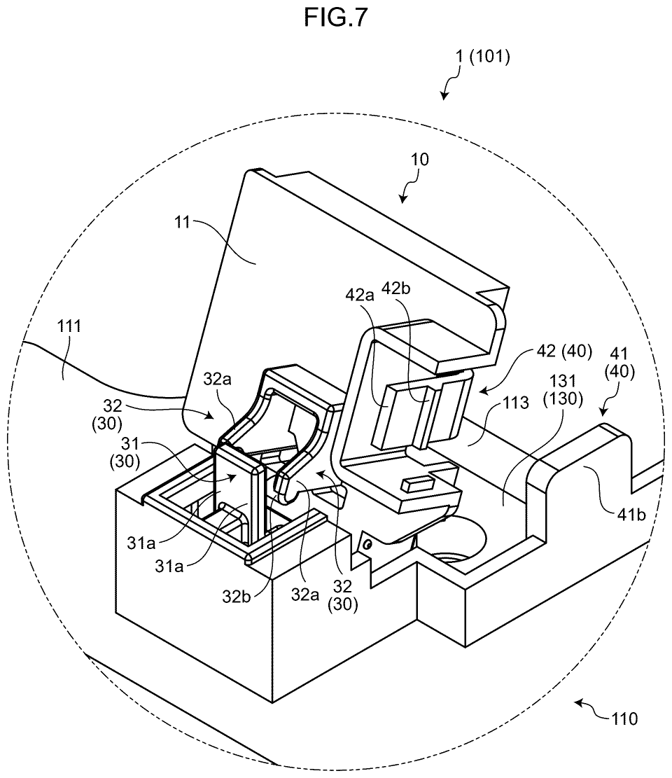

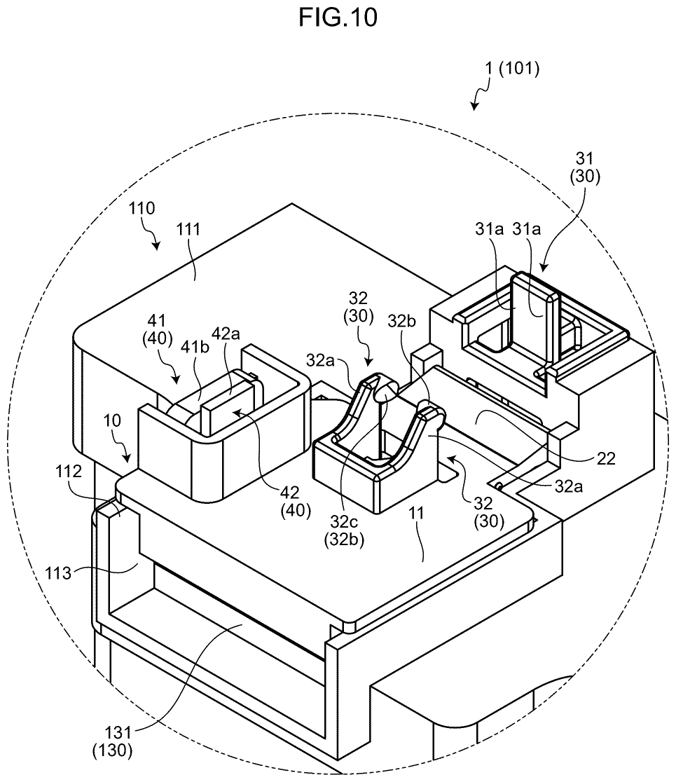

In the electrical connection box 101, the protective cover 10 exposes the electrical connecting portion 131 together with the opening 112 at the open position (FIGS. 7 to 9) with respect to the cover member 110, and covers the opening 112 and the electrical connecting portion 131 with the cover main body 11 at the closed position (FIG. 10) with respect to the cover member 110.

In the electrical connection box 101, the cover member 110 is provided with the rotation shaft 21, and the protective cover 10 is provided with the bearing 22.

Hereinafter, the temporary holding mechanism 30 will be specifically described using the electrical connection box 101.

The first locking body 31 has a locking portion 31a configured to lock the first locked body 32 at the temporary holding position and hold it at that position on at least one of both ends as viewed in the axial direction of the rotation shaft 21 (FIGS. 1 to 3, 6, 7, and 10). In addition, the first locked body 32 includes a cantilevered flexible portion 32a that projects out from the cover main body 11 in the opening direction and that is deflection deformable in the axial direction of the rotation shaft 21, and a locked protrusion 32b that projects out from a free end of the flexible portion 32a in the axial direction of the rotation shaft 21 and that is locked to the locking portion 31a at the temporary holding position and held at that position (FIGS. 1, 2, 5 to 7, and 9 to 10). The flexible portion 32a is arranged to face the locking portion 31a in the axial direction of the rotation shaft 21 at the temporary holding position. Then, the free end of the flexible portion 32a is disposed closer to the opening direction side than the locking portion 31a at the temporary holding position. That is, in the temporary holding mechanism 30, the protective cover 10 is held at the temporary holding position by sandwiching the locking portion 31a between the cover main body 11 and the locked protrusion 32b at the temporary holding position.

Specifically, the first locking body 31 has the locking portions 31a at each of both ends when viewed in the axial direction of the rotation shaft 21 (FIGS. 1 to 3, 6, 7, and 10). Furthermore, the protective cover 10 is provided with the first locked body 32 for each locking portion 31a (FIGS. 1, 2, 6, 7, and 10).

The first locking body 31 illustrated here is formed in a cantilever shape projecting out with the main body 111 side of the cover member serving as the assembly object 110 as a fixed end, and in a rectangular one-piece shape having each of both ends as viewed in the axial direction of the rotation shaft 21 as side portions lying along a projecting direction from the main body 111 (FIGS. 1 to 3, 6, 7, and 10). In the first locking body 31, a portion of the side portion is used as the locking portion 31a.

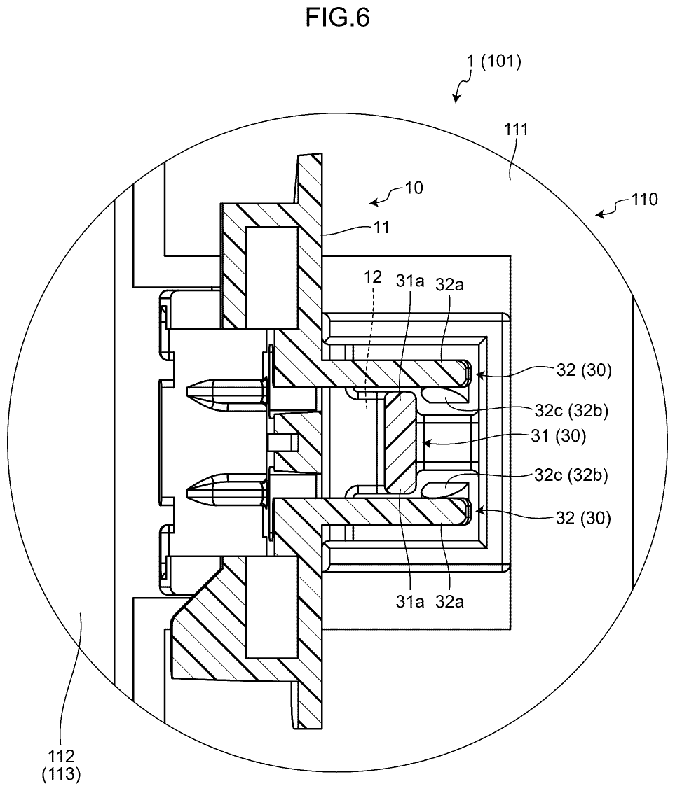

The protective cover 10 is assembled to the cover member serving as the assembly object 110 in an assembly direction opposite to the projecting direction of the first locking body 31 (FIGS. 1 to 4). As described above, in the protective cover 10, the locking portion 31a is sandwiched between the cover main body 11 and the locked protrusion 32b at the temporary holding position (FIG. 6). In the protective cover 10 at the temporary holding position, a state in which the locking portion 31a is sandwiched between the cover main body 11 and the locked protrusion 32b is obtained for each first locked body 32 (FIG. 6). That is, the protective cover 10 has a space portion 12 surrounded by the cover main body 11, the pair of flexible portions 32a, and the pair of locked protrusions 32b, and the first locking body 31 is inserted into the space portion 12 at the temporary holding position (FIGS. 1 and 6). The first locking body 31 is inserted into the space portion 12 from the free end when assembling the protective cover 10 to the cover member serving as the assembly object 110. In other words, the first locking body 31 is inserted into the space portion 12 from the free end thereof in conjunction with the assembly operation of the protective cover 10 to the cover member serving as the assembly object 110. That is, the pair of first locked bodies 32 is formed such that the first locking body 31 can be inserted into the space portion 12 from the free end thereof in conjunction with the assembly operation of the protective cover 10 to the cover member serving as the assembly object 110.

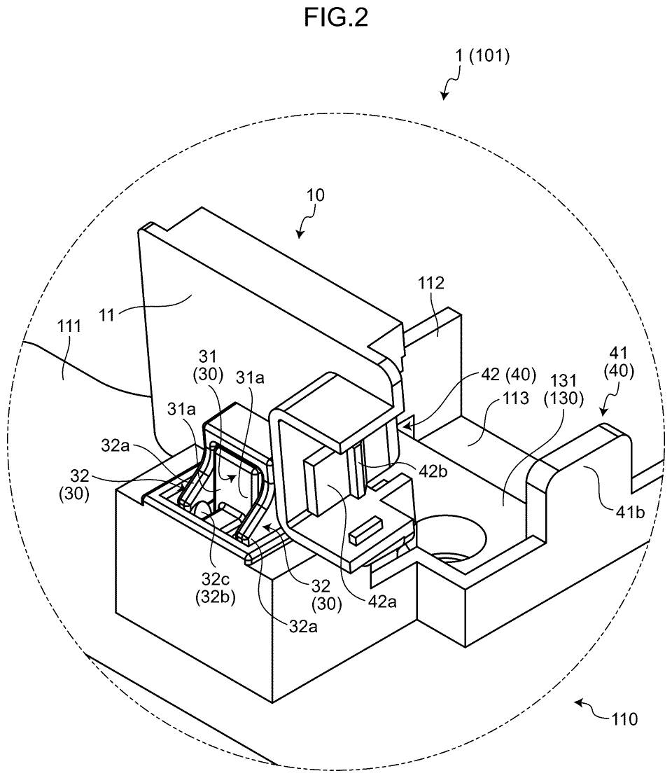

Furthermore, the bearing 22 includes an insertion port 22a into which the rotation shaft 21 is inserted in conjunction with the assembly operation of the protective cover 10 to the cover member serving as the assembly object 110, and a bearing portion 22b configured to support the rotation shaft 21 inserted from the insertion port 22a in a freely rotating manner (FIGS. 1, 3, 5, and 9). Therefore, the protective cover 10 is temporarily held at the temporary holding position by being assembled to the cover member serving as the assembly object 110 (FIGS. 2, 4, and 5).

The electrical connection box 101 is manufactured at one place and conveyed to another place to physically and electrically connect the counterpart conductive component to the electrical connecting portion 131. The electrical connection box 101 is conveyed from the manufacturing place to the connecting place of the counterpart conductive component in a state in which the protective cover 10 is temporarily held at the temporary holding position. Therefore, the protective cover 10 is displaced from the temporary holding position to the closed position after the counterpart conductive component is connected.

Thus, the locked protrusion 32b is provided with an input portion 32c that applies a force to an abutment position with the locking portion 31a when turning the protective cover 10 at the temporary holding position in the closing direction to receive a reaction force of the force from the abutment position with the locking portion 31a, and deflection deforms the flexible portion 32a to cause it to go over the locking portion 31a (FIGS. 1, 2, 5, 6, 9, and 10).

The input portion 32c is a wall surface inclined with respect to the axial direction of the rotation shaft 21 and arranged to face the locking portion 31a at an abutment position with the locking portion 31a, and is formed as an inclined surface in which the projection amount from the free end of the flexible portion 32a decreases toward the closing direction (FIGS. 1, 2, 6, 9, and 10). Therefore, in the protective cover 10, when a force in the closing direction is applied at the temporary holding position, the input portion 32c of the locked protrusion 32b abuts on the locking portion 31a to apply a force, and the input portion 32c receives a reaction force of the force from the abutment position with the locking portion 31a, so that the flexible portion 32a is deflection deformed. In the protective cover 10, the deflection deformation amount of the flexible portion 32a increases by continuously acting the force in the closing direction, and the locked protrusion 32b goes over the locking portion 31a. As a result, the protective cover 10 reaches the open position and can be displaced to the closed position as it is.

For example, the locked protrusion 32b illustrated here has a circular column having an axis parallel to the axis of the rotation shaft 21 as a main body, and the input portion 32c is formed by cutting a part of the circular column into an inclined surface shape (FIGS. 1, 2, 6, 9, and 10).

In addition, the protective cover 10 is opened from the closed position when performing maintenance inspection or the like. The protective cover 10 locks the movement of the locked protrusion 32b in the opening direction to the locking portion 31a at the open position. Here, after the protective cover 10 is temporarily displaced from the temporary holding position to the open position, the protective cover 10 is prevented from returning to the temporary holding position again. Therefore, the locking portion 31a and the locked protrusion 32b are formed in a shape capable of stopping the protective cover 10 at the open position by continuing to lock the locked protrusion 32b with the locking portion 31a when a force in the opening direction is acted on the protective cover 10 at the open position (FIGS. 7 to 9). In this example, an arc-shaped outer peripheral surface of the main body portion of the locked protrusion 32b is abutted on the locking portion 31a. Accordingly, the locking portion 31a can continuously lock the locked protrusion 32b.

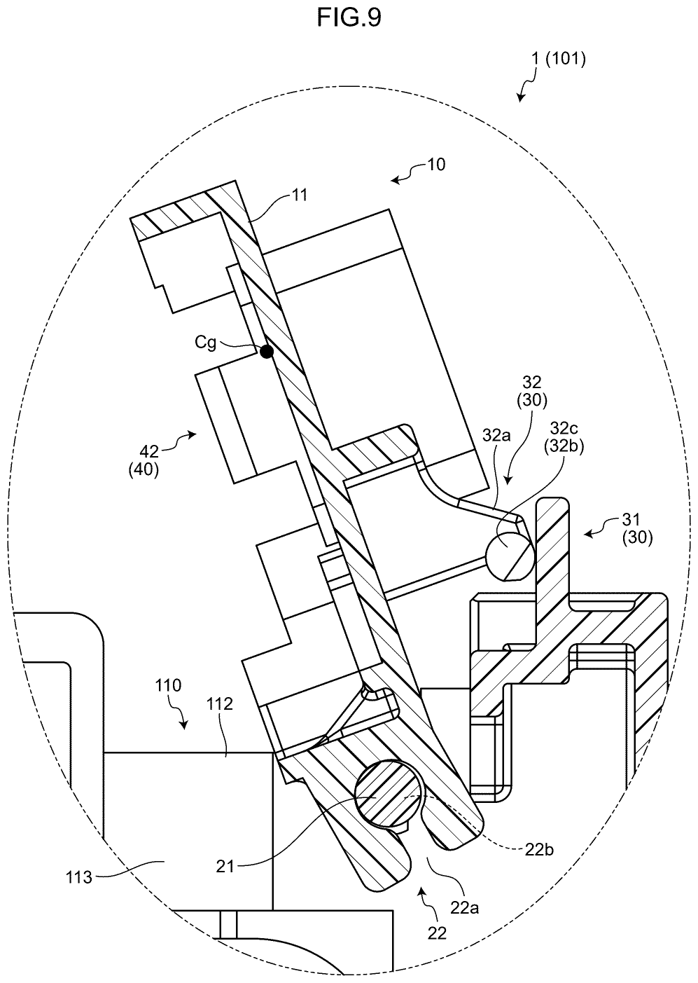

Here, the protective cover 10 is formed to have a center of gravity Cg eccentric to the closed position side from the vertically upper side of the rotation shaft 21 around the axis of the rotation shaft 21 at the open position (FIG. 9). Therefore, the protective cover 10 at the open position returns to the closed position by its own weight if no force is applied.

As described above, since the assembly structure 1 of the protective cover 10 and the electrical connection box 101 of the present embodiment can keep the protective cover 10 in the state of being opened at the temporary holding position, for example, it can be conveyed in a state in which the protective cover 10 is opened. Therefore, the assembly structure 1 of the protective cover 10 and the electrical connection box 101 can enable the connection work using the opening 112 to be performed while being in a conveyed state, and hence the assembly workability can be improved.

Furthermore, in the assembly structure 1 of the protective cover 10 and the electrical connection box 101 of the present embodiment, when the protective cover 10 is turned in the closing direction from the temporary holding position, the protective cover 10 can be turned from the temporary holding position to the open position with a light force using the flexible portion 32a and the input portion 32c of the locked protrusion 32b.

Moreover, in the assembly structure 1 of the protective cover 10 and the electrical connection box 101 of the present embodiment, after the protective cover 10 is temporarily displaced from the temporary holding position to the open position, the protective cover 10 is prevented from returning to the temporary holding position again. In the assembly structure 1 of the protective cover 10 and the electrical connection box 101 of the present embodiment, the center of gravity Cg of the protective cover 10 is set as described above, and the protective cover 10 returns to the closed position by its own weight if no force is applied to the protective cover 10 at the open position. Therefore, the assembly structure 1 of the protective cover 10 and the electrical connection box 101 can prevent the protective cover 10 from being left open.

Here, the assembly structure 1 of the protective cover 10 and the electrical connection box 101 of the present embodiment are provided with a holding mechanism 40 configured to hold the protective cover 10 at the closed position (FIGS. 1 to 4). The holding mechanism 40 includes a locking body (hereinafter referred to as a “second locking body”) 41 provided on the cover member serving as the assembly object 110 and a locked body (hereinafter referred to as a “second locked body”) 42 provided on the protective cover 10, and holds the protective cover 10 at the closed position by locking them to each other (FIGS. 1 to 4). The second locking body 41 has a groove portion 41a, and a part of a peripheral wall of the groove portion 41a is used as the locking portion 41b (FIGS. 1 to 4). The second locked body 42 includes a flexible piece portion 42a having a cantilever shape and formed in a one-piece shape having flexibility, and a claw portion 42b projecting out from one plane of the flexible piece portion 42a (FIGS. 1 to 4).

In the second locking body 41 and the second locked body 42, when the protective cover 10 is being closed toward the closed position, the claw portion 42b abuts on the locking portion 41b of the peripheral wall of the groove portion 41a, and in this state, a force in the closing direction is applied to the protective cover 10, whereby the claw portion 42b goes over the locking portion 41b while deflection deforming the flexible piece portion 42a. As a result, in the second locking body 41 and the second locked body 42, the claw portion 42b enters the groove portion 41a, so that the claw portion 42b is arranged at a position of being able to lock to the locking portion 41b in the groove portion 41a. The protective cover 10 reaches the closed position as the claw portion 42b enters the groove portion 41a. The second locking body 41 and the second locked body 42 can hold the protective cover 10 at the closed position by locking the claw portion 42b to the locking portion 41b in the groove portion 41a. Since the assembly structure 1 of the protective cover 10 and the electrical connection box 101 illustrated here include such a holding mechanism 40, when the protective cover 10 at the open position is closed by its own weight, the claw portion 42b abuts on the locking portion 41b, and the movement of the protective cover 10 stops at that position. However, in the assembly structure 1 of the protective cover 10 and the electrical connection box 101, since the protective cover 10 is closed by its own weight to a position covering the opening 112, the protective cover 10 can be prevented from being left open. Note that it is necessary to push the protective cover 10 so that the claw portion 42b enters the groove portion 41a.

Although not illustrated, the temporary holding mechanism 30 may be configured such that the protective cover 10 is provided with the first locking body 31, and the cover member serving as the assembly object 110 is provided with the first locked body 32. In this case, in the first locked body 32, the flexible portion 32a is projected out in the closing direction from the main body 111 of the cover member serving as the assembly object 110, and the locked protrusion 32b is provided at the distal end (free end) of the projected tip of the flexible portion 32a.

An assembly structure of a protective cover and an electrical connection box according to the present embodiment can keep a protective cover in a state of being opened at a temporary holding position, and thus for example, it can be conveyed in a state in which the protective cover is opened. Therefore, the assembly structure of the protective cover and the electrical connection box can enable the connection work using the opening to be performed while being in a conveyed state, and hence the assembly workability can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An assembly structure of a protective cover, comprising:
a protective cover configured to expose an opening of a main body of an assembly object at an open position with respect to the assembly object and cover the opening with a cover main body at a closed position with respect to the assembly object;
a rotation shaft provided on one of the protective cover and the assembly object;
a bearing provided on the other of the protective cover and the assembly object, the bearing enabling the protective cover to turn around an axis of the rotation shaft between the open position and the closed position; and
a temporary holding mechanism configured to temporarily hold the protective cover at a temporary holding position by locking a first locked body of the protective cover to a first locking body of the assembly object at the temporary holding position further turned in an opening direction than the open position, wherein
the first locking body includes a locking portion that locks the first locked body at the temporary holding position and holds the first locked body at the position on at least one of both ends as viewed in an axial direction of the rotation shaft,
the first locked body includes a cantilevered flexible portion that projects out from the cover main body in the opening direction and is deflection deformable in the axial direction, and a locked protrusion that projects out from a free end of the flexible portion in the axial direction, is locked to the locking portion at the temporary holding position, and is held at the position, and
the locked protrusion is provided with an input portion that, by applying a force to an abutment position with the locking portion when the protective cover at the temporary holding position is turned in a closing direction, receives a reaction force of the force from the abutment position and deflection deforms the flexible portion to go over the locking portion.

2. The assembly structure of the protective cover according to claim 1, wherein
the flexible portion is disposed to face the locking portion in the axial direction at the temporary holding position, and the free end is disposed closer to the opening direction side than the locking portion at the temporary holding position, and
the input portion is a wall surface inclined with respect to the axial direction and disposed to face the locking portion at the abutment position, and is formed as an inclined surface in which a projection amount of the flexible portion from the free end is reduced toward the closing direction.

3. The assembly structure of the protective cover according to claim 2, wherein
the first locking body has the locking portion at each of the both ends as viewed in the axial direction, and
the first locked body is provided in the protective cover for each of the locking portions.

4. The assembly structure of the protective cover according to claim 3, wherein
the first locking body is formed in a cantilever shape projecting out with the main body side of the assembly object as a fixed end, and in a rectangular one-piece shape having each of the both ends as viewed in the axial direction as side portions lying along a projecting direction from the main body,
the protective cover is assembled to the assembly object in an assembly direction opposite to the projecting direction of the first locking body, and includes a space portion surrounded by the cover main body, a pair of the flexible portions, and a pair of the locked protrusions,
a pair of the first locked bodies is formed such that the first locking body is insertable into the space portion from a free end of the first locking body in conjunction with an assembly operation of the protective cover to the assembly object, and
the bearing includes an insertion port into which the rotation shaft is inserted in conjunction with the assembly operation of the protective cover to the assembly object, and a bearing portion that supports the rotation shaft inserted from the insertion port in a freely rotating manner.

5. The assembly structure of the protective cover according to claim 1, wherein the protective cover is formed to lock movement of the locked protrusion in the opening direction to the locking portion at the open position, and have a center of gravity eccentric to the closed position side than a vertically upper side of the rotation shaft around the axis of the rotation shaft at the open position.

6. The assembly structure of the protective cover according to claim 2, wherein the protective cover is formed to lock movement of the locked protrusion in the opening direction to the locking portion at the open position, and have a center of gravity eccentric to the closed position side than a vertically upper side of the rotation shaft around the axis of the rotation shaft at the open position.

7. The assembly structure of the protective cover according to claim 3, wherein the protective cover is formed to lock movement of the locked protrusion in the opening direction to the locking portion at the open position, and have a center of gravity eccentric to the closed position side than a vertically upper side of the rotation shaft around the axis of the rotation shaft at the open position.

8. The assembly structure of the protective cover according to claim 4, wherein the protective cover is formed to lock movement of the locked protrusion in the opening direction to the locking portion at the open position, and have a center of gravity eccentric to the closed position side than a vertically upper side of the rotation shaft around the axis of the rotation shaft at the open position.

9. The assembly structure of the protective cover according to claim 5, wherein the locking portion and the locked protrusion are formed in a shape enabling the protective cover to be stopped at the open position by continuously locking the locked protrusion with the locking portion when a force in the opening direction is applied to the protective cover at the open position.

10. The assembly structure of the protective cover according to claim 6, wherein the locking portion and the locked protrusion are formed in a shape enabling the protective cover to be stopped at the open position by continuously locking the locked protrusion with the locking portion when a force in the opening direction is applied to the protective cover at the open position.

11. The assembly structure of the protective cover according to claim 7, wherein the locking portion and the locked protrusion are formed in a shape enabling the protective cover to be stopped at the open position by continuously locking the locked protrusion with the locking portion when a force in the opening direction is applied to the protective cover at the open position.

12. The assembly structure of the protective cover according to claim 8, wherein the locking portion and the locked protrusion are formed in a shape enabling the protective cover to be stopped at the open position by continuously locking the locked protrusion with the locking portion when a force in the opening direction is applied to the protective cover at the open position.

13. The assembly structure of the protective cover according to claim 5, further comprising a holding mechanism configured to include a second locking body provided on the assembly object and a second locked body provided on the protective cover, and hold the protective cover at the closed position by locking the second locking body and the second locked body to each other.

14. The assembly structure of the protective cover according to claim 6, further comprising a holding mechanism configured to include a second locking body provided on the assembly object and a second locked body provided on the protective cover, and hold the protective cover at the closed position by locking the second locking body and the second locked body to each other.

15. The assembly structure of the protective cover according to claim 7, further comprising a holding mechanism configured to include a second locking body provided on the assembly object and a second locked body provided on the protective cover, and hold the protective cover at the closed position by locking the second locking body and the second locked body to each other.

16. The assembly structure of the protective cover according to claim 8, further comprising a holding mechanism configured to include a second locking body provided on the assembly object and a second locked body provided on the protective cover, and hold the protective cover at the closed position by locking the second locking body and the second locked body to each other.

17. An assembly structure of a protective cover, comprising:
a protective cover configured to expose an opening of a main body of an assembly object at an open position with respect to the assembly object and cover the opening with a cover main body at a closed position with respect to the assembly object;
a rotation shaft provided on one of the protective cover and the assembly object;
a bearing provided on the other of the protective cover and the assembly object, the bearing enabling the protective cover to turn around an axis of the rotation shaft between the open position and the closed position; and
a temporary holding mechanism configured to temporarily hold the protective cover at a temporary holding position by locking a first locked body of the assembly object to a first locking body of the protective cover at the temporary holding position further turned in an opening direction than the open position, wherein
the first locking body includes a locking portion that locks the first locked body at the temporary holding position and holds the first locked body at the position on at least one of both ends as viewed in an axial direction of the rotation shaft,
the first locked body includes a cantilevered flexible portion that projects out from the main body of the assembly object in the closing direction and is deflection deformable in the axial direction, and a locked protrusion that projects out from a free end of the flexible portion in the axial direction, is locked to the locking portion at the temporary holding position, and is held at the position, and
the locked protrusion is provided with an input portion that, by applying a force to an abutment position with the locking portion when the protective cover at the temporary holding position is turned in the closing direction, receives a reaction force of the force from the abutment position and deflection deforms the flexible portion to go over the locking portion.

18. An electrical connection box comprising:
an accommodation member configured to accommodate, in an accommodation chamber, an electrical connecting member provided with an electrical connecting portion for physically and electrically connecting a counterpart conductive component;
a cover member assembled to the accommodation member to cover the accommodation chamber with a main body, and configured to expose the electrical connecting portion from an opening of the main body;
a protective cover configured to expose the electrical connecting portion together with the opening at an open position with respect to the cover member, and covers the opening and the electrical connecting portion with a cover main body at a closed position with respect to the cover member;
a rotation shaft provided on one of the protective cover and the cover member;
a bearing provided on the other of the protective cover and the cover member and configured to be able to turn the protective cover around an axis of the rotation shaft between the open position and the closed position; and
a temporary holding mechanism configured to temporarily hold the protective cover at a temporary holding position by locking a first locked body of the protective cover to a first locking body of the cover member at the temporary holding position further turned in an opening direction than the open position, wherein
the first locking body includes a locking portion that locks the first locked body at the temporary holding position and holds the first locked body at the position on at least one of both ends as viewed in the axial direction of the rotation shaft,
the first locked body includes a cantilevered flexible portion that projects out from the cover main body in the opening direction and is deflection deformable in the axial direction, and a locked protrusion that projects out from a free end of the flexible portion in the axial direction, is locked to the locking portion at the temporary holding position, and is held at the position, and
the locked protrusion is provided with an input portion that, by applying a force to an abutment position with the locking portion when the protective cover at the temporary holding position is turned in a closing direction, receives a reaction force of the force from the abutment position and deflection deforms the flexible portion to go over the locking portion.
